(19) United States
(12) Patent Application Publication
(10) Pub. No.: US 2005/0125642 A1
(43) Pub. Date: Jun. 9, 2005

(54) Dynamically reconfigurable logic circuit device, interrupt control method, and semi-conductor integrated circuit

(76) Inventor: Tomoo Kimura, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/002,059

(22) Filed: Dec. 3, 2004

(30) Foreign Application Priority Data
Dec. 5, 2003 (JP) 2003-407644

(51) Int. Cl. G06F 15/00

(52) U.S. Cl. 712/226

(57) ABSTRACT

A dynamically reconfigurable logic circuit device includes a plurality of dynamically reconfigurable processor units (DRPU) arranged in array, and a plurality of dynamically connecting units (DCU). The dynamically connecting units interconnect inputs and outputs of the dynamically reconfigurable processor units. Each of the dynamically reconfigurable processor units includes a plurality of arithmetic processing configurations, a plurality of input data storage units, and a plurality of output data storage units. The arithmetic processing configurations, input data storage units, and output data storage units are both selected and set up in accordance with an interrupting signal from an interrupt controller. Similarly, the interconnection of the dynamically reconfigurable processor units through the dynamically connecting units is performed in accordance with the interrupting signal. The above structure is operable to change input data as well as the arithmetic processing configurations upon the issuance of a request for interrupt from a CPU, and to change the entire logic circuit configuration. As a result, time-division multiplexing is achievable.

### BACKGROUND OF THE INVENTION

1. Field of the Invention

The present invention relates to a dynamically reconfigurable logic circuit device possessing a logic configuration dynamically changeable by programs, and an art related thereto, in particular, an art operable to change the logic configuration in response to an interrupting signal.

2. Description of the Related Art

To successfully combine flexible software processing with high-speed hardware processing, a typical dynamically reconfigurable logic circuit device (in general called a dynamic reconfigurable logic or DRL) possessing a program-changeable logic configuration has recently been proposed.

In the past, FPGA (a field programmable gate array) and PLD (a programmable logic device) are widely known as devices incorporating the program-changeable logic configurations. The FPGA and PLD are designed to dynamically change connections between transistors to a certain degree. However, it takes some time to complete such a connection change. In addition, it is difficult that the FPGA as well as the PLD changes the connections, in the course of treating another task, to provide different logic configurations.

In contrast, the recently proposed dynamically reconfigurable logic circuit device as just discussed above is possible to rapidly change its logic configuration. For example, Reference No. 1 (JP A 08-101761) discloses a dynamically reconfigurable logic circuit device possessing changeable computing cells arranged in array, and an art operable to produce the same.

Referring to FIG. 11, the computing cell, part of the dynamically reconfigurable logic circuit device used hitherto, as disclosed in Reference No. 1, is illustrated schematically in block diagram form to focus on functions of the computing cell. As illustrated in FIG. 11, the computing cell 1 includes flip-flops 2, 4 operable to retain input data, computing devices 3, 5 operable to perform either shift or mask operation, a computing device 6 operable to perform addition and subtraction, a flip-flop 7 operable to retain output data, and a setting register 8 operable to store information on the former configurations. A change in setting information in the setting register 8 provides different logic configurations in the computing cell 1.

In the dynamically reconfigurable logic circuit device as disclosed in Reference No. 1, processing units such as the computing cell 1 are arranged in array to change the logic configurations of the computing cells as well as interconnections between the computing cells in accordance with programs. This feature provides a re-programmable, dynamically reconfigurable logic circuit device that is substantially equal in performance to dedicated logic circuits. In addition, the dynamically reconfigurable logic circuit device as disclosed in Reference No. 1 is reconfigurable in logics in a shorter time than statically reconfigurable logic circuit devices such as the FPGA and PLD, and is changeable in logic configuration during service operation. This means that the dynamically reconfigurable logic circuit device as disclosed in Reference No. 1 finds wide application in the industrial field.

However, the currently available dynamically reconfigurable logic circuit devices as represented by the disclosed dynamically reconfigurable logic circuit device require several clock periods to perform processing. This requirement is incurred by the structural disadvantage of many arithmetic processing steps from input to output. The structural disadvantage precludes high-speed processing to be carried out by the dynamically reconfigurable logic circuit devices, and each of the currently available dynamically reconfigurable logic circuit devices is slower in action than clock-synchronized, neighboring circuits. As a result, the neighboring circuits often must wait for the next step until the dynamically reconfigurable logic circuit device completes the present processing.

General-purpose processors such as DSP and CPU are highly re-programmable because of program-driven free processing, but they are low in processing speed because their signal-processing logics are realized by software, not by hardware.

In order to overcome the above problems, Reference No. 2 (“Hyper-Threading Technology, Intel Research and Development” supplied by the Intel Corporation, http://www.intel.com/labs/htt/index.htm, downloaded on Oct., 6, 2003) discloses a multi-thread circuit and art operable to provide a switchover of flip-flops (FF) located in a processor between pipelines, thereby providing virtual reality in which several different processing steps are executed in parallel on the single processor.

The general-purpose processor incorporating the multi-thread circuit and art as just discussed above has a processing capability increased by performing time-division processing of tasks. However, this technique is essentially premised on high-speed operation of the general-purpose processor. This causes another disadvantage of an increase in power consumption.

As described above, the dynamically reconfigurable logic circuit devices used hitherto are lower in both operating speed and processing capability per cycle than the neighboring circuits such as the CPU, and therefore there are great gaps in processing capability per cycle therebetween. In addition, the currently available dynamically reconfigurable logic circuit devices are unsuited for multi-thread processing performed by currently typical processors, and are consequently impossible to treat the time-division multiplexing. As a result, the currently available dynamically reconfigurable logic circuit devices cannot address processing to be carried out in real time.

### OBJECTS AND SUMMARY OF THE INVENTION

In view of the above, an object of the present invention is to provide a dynamically reconfigurable logic circuit device adapted for time-division multiplexing, and possessing an increased level of processing capability per cycle.

A first aspect of the present invention provides a dynamically reconfigurable logic circuit device including a plurality of dynamically reconfigurable processor units and at least one dynamically connecting unit. The dynamically connecting unit changes electrical connections between inputs and outputs of the dynamically reconfigurable processor units in a state in which an interrupting signal entering the dynamically connecting unit from the outside of the dynamically connecting unit is rendered operative as a trigger. As a result, different logic circuits are configured in the dynamically reconfigurable logic circuit device.

The above construction provides the dynamically reconfigurable logic circuit device possessing a logic configuration changeable to a different one in response to the interrupting signal from the outside of the dynamically reconfigurable logic circuit device. As a result, the logic configuration required for interrupt processing is conveniently and instantly available, and the interrupt processing is achievable.

In the dynamically reconfigurable logic circuit device as discussed above, each of the dynamically reconfigurable processor units may possess a plurality of arithmetic processing configurations changeable in a state in which the interrupting signal entering each of the dynamically reconfigurable processor units from the outside of each of the dynamically reconfigurable processor units is rendered operative as the trigger.

Pursuant to the above construction, one of the arithmetic processing configurations in each of the dynamically reconfigurable processor units is selected in response to the interrupting signal from the outside of each of the dynamically reconfigurable processor units, thereby changing the arithmetic processing configurations. As a result, the arithmetic processing configurations required for interrupt processing are conveniently and instantly available, and the interrupt processing is executable.

In the dynamically reconfigurable logic circuit device as discussed above, each of the dynamically reconfigurable processor units may include: at least one computing unit; a setting information storage unit operable to store setting information for use in setting different arithmetic processing configurations in combination with the computing unit; at least one input data storage unit operable to retain data to be entered into each of the dynamically reconfigurable processor units; a setting information-switching unit operable to provide a switchover of the setting information to be read out from the setting information storage unit; and an input data-switching unit operable to provide a switchover of the input data storage unit. The setting information-switching unit and input data-switching unit execute respective switchovers in a state in which the interrupting signal entering each of the dynamically reconfigurable processor units from the outside of each of the dynamically reconfigurable processor units is rendered operative as the trigger. As a result, the different arithmetic processing configurations are provided in each of the dynamically reconfigurable processor units.

Pursuant to the above construction, the setting information storage unit is controlled in response to the interrupt signal from the outside of each of the dynamically reconfigurable processor units, and the input data and arithmetic processing configurations in each of the dynamically reconfigurable process units are changeable in accordance with results from the control over the setting information storage unit.

In the dynamically reconfigurable logic circuit device as discussed above, each of the dynamically reconfigurable processor units may include: at least one computing unit; a setting information storage unit operable to store setting information for use in setting different arithmetic processing configurations in combination with the computing unit; at least one input data storage unit operable to retain data to be entered into each of the dynamically reconfigurable processor units; at least one output data storage unit operable to retain data to be fed out of each of the dynamically reconfigurable processor units; a setting information-switching unit operable to provide a switchover of the setting information to be read out from the setting information storage unit; an input data-switching unit operable to provide a switchover of the input data storage unit; and an output data-switching unit operable to provide a switchover of the output data storage unit. The setting information-switching unit, input data-switching unit, and output data-switching unit execute respective switchovers in a state in which the interrupting signal entering each of the dynamically reconfigurable processor units from the outside of each of the dynamically reconfigurable processor units is rendered operative as the trigger. As a result, the different arithmetic processing configurations are provided in each of the dynamically reconfigurable processor units.

Pursuant to the above construction, the setting information storage unit is controlled in response to the interrupt signal from the outside of each of the dynamically reconfigurable processor units, and the input data, arithmetic processing configurations, and output data in each of the dynamically reconfigurable processor units are changeable in accordance with results from the control over the setting information storage unit.

In the dynamically reconfigurable logic circuit device as discussed above, input data to be entered in parallel into each of the dynamically reconfigurable processor units may be equal in number to output data to be fed in parallel out of each of the dynamically reconfigurable processor units.

Pursuant to the above construction, the dynamically reconfigurable logic circuit device is conveniently usable as a time-division multiplexing device. In particular, the connection of the dynamically reconfigurable processing units to cascades allows the dynamically reconfigurable logic circuit device to be readily applicable to multi-thread processing.

In the dynamically reconfigurable logic circuit device as discussed above, input data to be entered in parallel into each of the dynamically reconfigurable processor units may be greater in number than output data to be fed in parallel out of each of the dynamically reconfigurable processor units.

The above construction provides the dynamically reconfigurable logic circuit device suited to obtain a single result from the processing of several pieces of input data. In particular, a tree-like processing configuration possessing the dynamically reconfigurable processor units interconnected in a tree-like fashion is readily achievable.

In the dynamically reconfigurable logic circuit device as discussed above, the computing unit in each of the dynamically reconfigurable processor units may perform at least one of addition, subtraction, shift operation, mask operation, and bit manipulation.

The above constitution provides the dynamically reconfigurable logic circuit device operable to perform the addition, subtraction, shift operation, mask operation, and/or bit manipulation.

In the dynamically reconfigurable logic circuit device as discussed above, the dynamically connecting unit may include: at least one connection information storage unit operable to store connection information for use in interconnecting the dynamically reconfigurable processor units; and at least one connecting unit operable to electrically connect an output of one of the dynamically reconfigurable processor units to an input of another of the dynamically reconfigurable processor units. Readout of the connection information from the connection information storage unit and electrical connection of the dynamically reconfigurable processor units through the connecting unit are performed in a state in which the interrupting signal entering the dynamically connecting unit from the outside of the dynamically connecting unit is rendered operative as the trigger.

The above constitution provides the dynamically reconfigurable logic circuit device operable to control the connection information storage unit in response to the interrupting signal from the outside of the dynamically connecting unit, and operable to interconnect the dynamically reconfigurable processor units in accordance with results from the control over the connection information storage unit. As a result, different logic configurations are provided in the dynamically reconfigurable logic circuit device.

A second aspect of the present invention provides an interrupt control method for use in time-division multiplexing in a dynamically reconfigurable logic circuit device including a plurality of dynamically reconfigurable processor units and at least one dynamically connecting unit, in which the dynamically connecting unit changes electrical connections between inputs and outputs of the dynamically reconfigurable processor units, thereby allowing different logic circuits to be configured in the dynamically reconfigurable logic circuit device. The interrupt control method includes: transmitting an interrupting signal to the dynamically reconfigurable logic circuit device in response to the occurrence of interrupt processing higher in priority than processing currently underway, in which the interrupting signal is transmitted to address the interrupt processing; receiving the interrupting signal by the dynamically reconfigurable logic circuit device; reconfiguring by the dynamically reconfigurable logic circuit device a logic circuit required for the interrupt processing, in a state in which the interrupting signal received by the dynamically reconfigurable logic circuit device is rendered operative as a trigger; and executing the interrupt processing by the dynamically reconfigurable logic circuit device using the logic circuit reconfigured by the dynamically reconfigurable logic circuit device.

Pursuant to the above method, the logic circuit required for high-priority interrupt processing is configurable in the dynamically reconfigurable logic circuit device in the state in which the interrupting signal is rendered operative as the trigger. As a result, the interrupt processing can be practiced as time-division multiplexing.

In the interrupt control method as discussed above, in each of the plurality of dynamically reconfigurable processor units, the interrupt control method may include: transmitting an interrupting signal to the dynamically reconfigurable logic circuit device in response to the occurrence of interrupt processing higher in priority than processing currently underway, in which the interrupting signal is transmitted to address the interrupt processing; receiving the interrupting signal by each of the dynamically reconfigurable processor units; changing by each of the dynamically reconfigurable processor units its arithmetic processing configuration to an arithmetic processing configuration required for the interrupt processing, in a state in which the interrupting signal received by each of the dynamically reconfigurable processor units is rendered operative as the trigger; and executing the interrupt processing by each of the dynamically reconfigurable processor units using the arithmetic processing configuration changed by each of the dynamically reconfigurable processor units.

Pursuant to the above method, the arithmetic processing configuration of each of the dynamically reconfigurable processor units is changeable to the arithmetic processing configuration required by high-priority processing, in the state in which the interrupting signal is rendered operative as the trigger.

A third aspect of the present invention provides an interrupt control method for use in time-division multiplexing in a dynamically reconfigurable logic circuit device possessing a plurality of dynamically reconfigurable processor units. The interrupt control method includes: transmitting an interrupting signal to the dynamically reconfigurable logic circuit device in response to the occurrence of interrupt processing higher in priority than processing currently underway, in which the interrupting signal is transmitted to address the interrupt processing; receiving the interrupting signal by each of the dynamically reconfigurable processor units; selecting by each of the dynamically reconfigurable processor units input data required for the interrupt processing, in a state in which the interrupting signal received by each of the dynamically reconfigurable processor units is rendered operative as a trigger; selecting by each of the dynamically reconfigurable processor units setting information on an arithmetic processing configuration required for the interrupt processing; changing by each of the dynamically reconfigurable processor units the arithmetic processing configuration in accordance with the setting information; and executing the interrupt processing by each of the dynamically reconfigurable processor units using both of the input data selected by each of the dynamically configurable processor units and the arithmetic processing configuration changed by each of the dynamically reconfigurable processor units.

Pursuant to the above method, the setting information storage unit is controlled in the state in which the interrupting signal is rendered as the trigger, and the input data and arithmetic processing configuration are changeable in accordance with results from the control over the setting information storage unit.

A fourth aspect of the present invention provides an interrupt control method for use in time-division multiplexing in a dynamically reconfigurable logic circuit device having a plurality of dynamically reconfigurable processor units. The interrupt control method includes: transmitting an interrupting signal to the dynamically reconfigurable logic circuit device in response to the occurrence of interrupt processing higher in priority than processing currently underway, in which the interrupting signal is transmitted to address the interrupt processing; receiving the interrupting signal by each of the dynamically reconfigurable processor units; selecting by each of the dynamically reconfigurable processor units input data required for the interrupt processing, in a state in which the interrupting signal received by each of the dynamically reconfigurable processor units is rendered operative as a trigger; selecting by each of the dynamically reconfigurable processor units setting information on an arithmetic processing configuration required for the interrupt processing; changing by each of the dynamically reconfigurable processor units the arithmetic processing configuration in accordance with the setting information; executing the interrupt processing by each of the dynamically reconfigurable processor units using both of the input data selected by each of the dynamically configurable processor units and the arithmetic processing configuration changed by each of the dynamically reconfigurable processor units; and changing by each of the dynamically reconfigurable processor units a place where results from the interrupt processing are stored.

Pursuant to the above method, the setting information-switching unit, input data-switching unit, and output data-switching unit perform respective switchovers in the state in which the interrupting signal is rendered operative as the trigger. As a result, different arithmetic processing configurations are provided in each of the dynamically reconfigurable processor units.

A fifth aspect of the present invention provides a semi-conductor integrated circuit including a dynamically reconfigurable logic circuit device, a processor, and an interrupt control circuit. The processor prepares an arithmetic processing configuration required for interrupt processing, and notifies the interrupt control circuit of the arithmetic processing configuration. The interrupt control circuit prepares connection information on the dynamically reconfigurable logic circuit device in accordance with the arithmetic processing configuration required for the interrupt processing, and notifies the dynamically reconfigurable logic circuit device of the connection information together with an interrupting signal. The dynamically reconfigurable processor units in the dynamically reconfigurable logic circuit device change their arithmetic processing configurations in accordance with the setting information in a state in which the interrupting signal transmitted from the interrupt control circuit is rendered operative as a trigger. The dynamically connecting unit changes the electrical connections between the inputs and outputs of the dynamically reconfigurable processor units in accordance with the connection information. As a result, different logic circuits are configured in the dynamically reconfigurable logic circuit device.

The above construction provides the semi-conductor integrated circuit incorporating the dynamically reconfigurable logic circuit device operable to provide different logic circuits in dependence upon the interrupting signal from the processor.

In the semi-conductor integrated circuit as discussed above, the interrupt control circuit may be part of the processor.

The above construction provides a simpler structured semiconductor integrated circuit.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating a dynamically reconfigurable logic circuit device according to a first embodiment of the present invention, and a related part of a semi-conductor integrated circuit incorporating the former logic circuit device;

FIG. 2 is an illustration showing a first example of a connection network in the dynamically reconfigurable logic circuit device according the first embodiment;

FIG. 3 is an illustration showing a second example of a connection network in the dynamically reconfigurable logic circuit device according the first embodiment;

FIG. 4 is a block diagram illustrating a dynamically reconfigurable processor unit according to a second embodiment;

FIG. 5 is a block diagram illustrating details of the dynamically reconfigurable processor unit according to the second embodiment;

FIG. 6 is a block diagram illustrating a dynamically connecting unit according to a third embodiment;

FIG. 7 is a block diagram (fragmentary view) illustrating a dynamically reconfigurable logic circuit device incorporating the dynamically connecting units according to the third embodiment;

FIG. 8 is a block diagram illustrating a dynamically connecting unit according to a fourth embodiment;

FIG. 9 is a flowchart illustrating an interrupt control method according to a fifth embodiment in the dynamically reconfigurable logic circuit device;

FIG. 10 is a flowchart illustrating interrupt processing according to the fifth embodiment; and

FIG. 11 is a block diagram illustrating a processing unit which constitutes a dynamically reconfigurable logic circuit device used hitherto.

### DETAILED DESCRIPTION OF THE PREFERRED EMBODIMENTS

Preferred embodiments of the present invention are now described in conjunction with the accompanying drawings.

### First Embodiment

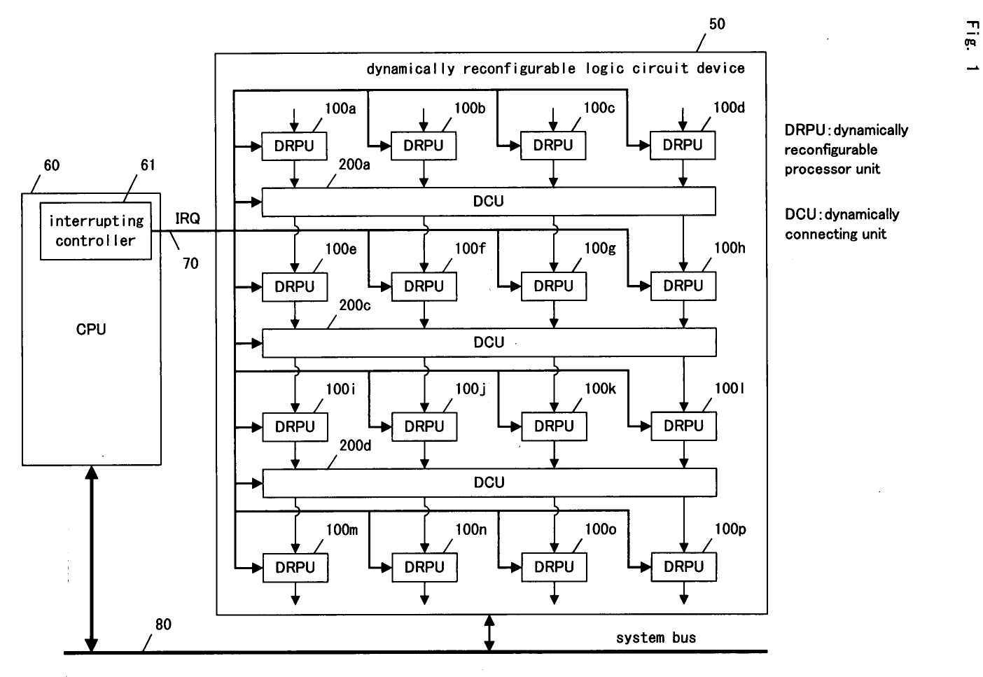

FIG. 1 shows a block diagram illustrating a dynamically reconfigurable logic circuit device according to a first embodiment and a related part of a semi-conductor integrated circuit incorporating the dynamically reconfigurable logic circuit device. The related part of a semi-conductor integrated circuit includes a CPU 60, the dynamically reconfigurable logic circuit device 50, and a system buss 80. The CPU 60 includes an interrupting controller 61. The interrupting controller 61 is operable to transmit an interrupting signal (IRQ) 70 to the dynamically reconfigurable logic circuit device 50. Data are transferred through the system buss 80 between the dynamically reconfigurable logic circuit device 50 and the CPU 60 and other units (not shown) of the semi-conductor integrated circuit.

The dynamically reconfigurable logic circuit device 50 includes a plurality of dynamically reconfigurable processor units (DRPU) “100a” to “100p” arranged in array (hereinafter referred to as dynamically reconfigurable processor units 100 when they are to be collectively called) and a plurality of dynamically connecting units (DCU) “200a”, “200c”, and “200d” (hereinafter referred to as dynamically connecting units 200 when they are to be collectively called). In the dynamically reconfigurable logic circuit device 50, the dynamically reconfigurable processor units 100 may be arranged in layered structure such that the dynamically connecting units (DCU) 200 interconnect inputs and outputs of the dynamically reconfigurable processor units 100, except for inputs of the dynamically reconfigurable processor units 100 in the first layer and outputs thereof in the last layer. The system buss 80 is connected to the inputs of the dynamically reconfigurable processor units 100 in the first layer and the outputs thereof in the last layer.

Each of the dynamically reconfigurable processor units 100 may possess a plurality of arithmetic processing configurations both selected and set up in a state in which the interrupting signal 70 is rendered operative as a trigger. Similarly, the dynamically reconfigurable processor units 100 may be connected to the dynamically connecting units 200 in the state in which the interrupting signal 70 is rendered operative as the trigger. The dynamically reconfigurable processor units 100 and dynamically connecting units 200 are amplified in other embodiments of the present invention as described later.

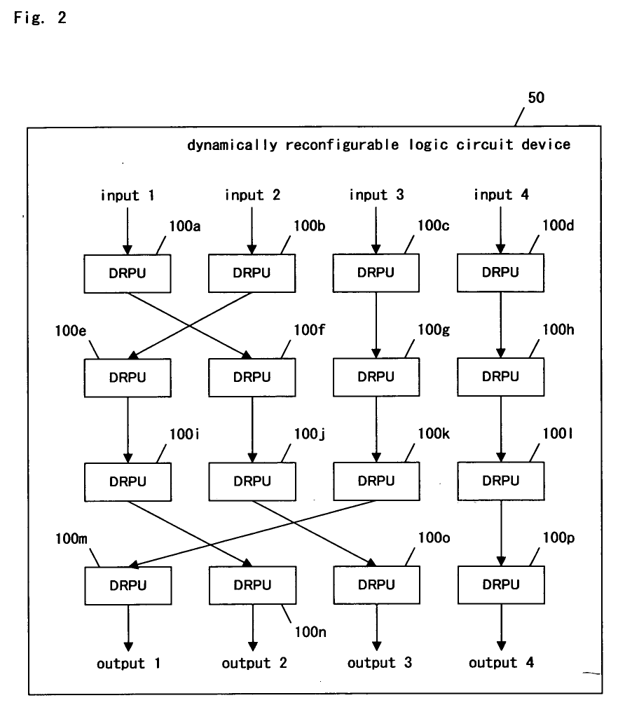

Turning now to FIG. 2, the dynamically reconfigurable logic circuit device 50 according to the present embodiment is shown, as a first example of a connection network, having sixteen numbers of the dynamically reconfigurable processor units 100 arranged in a four-by-four array, and having the inputs and outputs of the dynamically reconfigurable processor units 100 connected together through the dynamically connecting units 200. Arrows in FIG. 2 illustrate how the dynamically connecting units 200 hierarchically interconnect the dynamically reconfigurable processor units 100; however, the dynamically connecting units 200 are not illustrated as elements in FIG. 2. The interrupting signal 70 is omitted from FIG. 2.

As illustrated in FIG. 2, according to the first example of the connection network, an input 1 is processed in sequence at the dynamically reconfigurable processor units “100a,” “100f”, “100j”, and “100o”, thereby resulting in an output 3. An input 2 is processed in sequence at the dynamically reconfigurable processor units “100b”, “100e”, “100i”, and “100n”, thereby resulting in an output 2. An input 3 is processed in sequence at the dynamically reconfigurable processor units “100c”, “100g”, “100k”, and “100m”, thereby resulting in an output 1. An input 4 is processed in sequence at the dynamically reconfigurable processor units “100d”, “100h”, “100l”, and “100p”, thereby resulting in an output 4.

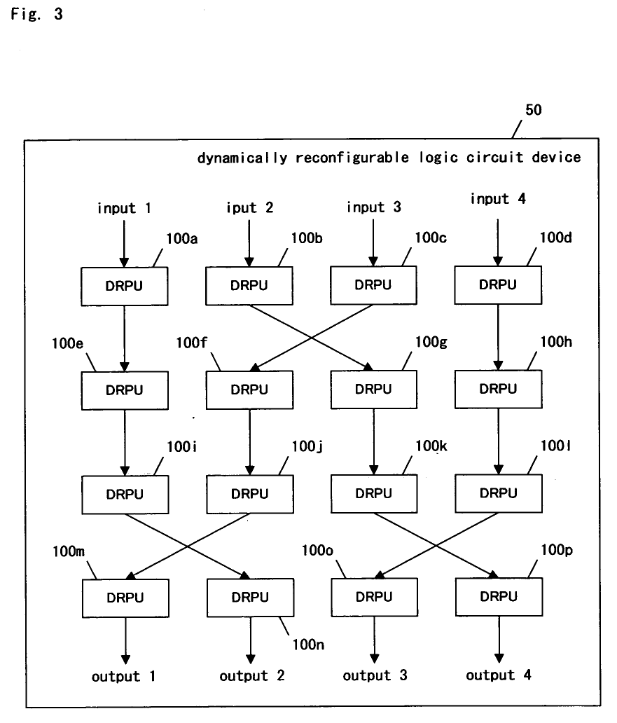

Turning now to FIG. 3, the dynamically reconfigurable processor units 100 according to the present embodiment are shown linked hierarchically to each other as a second example of a connection network. As illustrated in FIG. 3, the dynamically reconfigurable logic circuit device 50 provides a switchover from the logic circuit configuration currently underway as illustrated in FIG. 2 to a logic circuit configuration required for interrupt processing in response to the transmission of the interrupting signal 70 from the interrupting controller 61 of FIG. 1 to the dynamically reconfigurable logic circuit device 50. Arrows in FIG. 3 illustrate how the dynamically connecting units 200 hierarchically interconnect the dynamically reconfigurable processor units 100; however, the dynamically connecting units 200 are not illustrated as elements in FIG. 3. The interrupting signal 70 is omitted from FIG. 3.

As seen from FIG. 3, according to the second example of the connection network or an example of the interrupt processing, an input 1 is processed in sequence at the dynamically reconfigurable processor units “100a”, “100e”, “100i”, and “100n”, thereby resulting in an output 2. An input 2 is processed in sequence at the dynamically reconfigurable processor units “100b”, “100g”, “100k”, and “100p”, thereby resulting in an output 4. An input 3 is processed in sequence at the dynamically reconfigurable processor units “100c”, “100f”, “100j”, and “100m”, thereby resulting in an output 1. An input 4 is processed in sequence at the dynamically reconfigurable processor units “100d”, “100h”, “100l”, and “100o”, thereby resulting in an output 3.

As described above, the dynamically reconfigurable logic circuit device 50 is operable to control the dynamically connecting units 200 in response to the interrupting signal 70, thereby changing the interconnections between the dynamically reconfigurable processor units 100. As a result, a desired logic circuit is provided in the dynamically reconfigurable logic circuit device 50. The dynamically reconfigurable logic circuit device 50 is operable to execute the interrupt processing based on the logic circuit configuration of FIG. 3, and is operable to return to the previous logic circuit configuration of FIG. 2 upon completion of the interrupt processing. As a result, the previous processing is continued. Thus, the dynamically reconfigurable logic circuit device 50 according to the present embodiment achieves four-input/four-output parallel processing and time-division multiplexing.

Although the present embodiment employs the sixteen numbers of the dynamically reconfigurable processor units 100 that forms part of the dynamically reconfigurable logic circuit device 50, the number of quantity thereof is not limited thereto. This means that any number of the dynamically reconfigurable processor units 100 is acceptable. Although the dynamically reconfigurable processor units 100 according to the present embodiment are arranged in the four-by-four array, the present embodiment is not limited thereto. In short, they may be arranged in any other fashion.

Pursuant to the present embodiment, the dynamically reconfigurable processor units 100 are connected to each other through the dynamically connecting units 200 in the layered structure; however, the present embodiment is not limited thereto. More specifically, they may be connected together in any other structure.

As illustrated in FIG. 1, each of the dynamically reconfigurable processor units 100 is of the one-input, one-output type. However, the present embodiment is not limited thereto in terms of the number of inputs and that of outputs. More specifically, the number of the inputs and outputs may be met by purposes. For example, an alternative dynamically reconfigurable processor unit of the two-input/one-output type may be used, and the dynamically reconfigurable logic circuit device 50 may be of a tree-structured logic circuit configuration.

### Second Embodiment

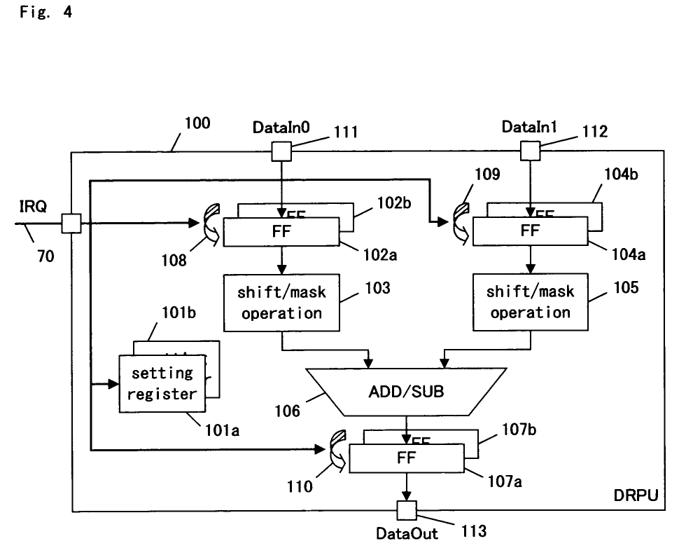

Referring to FIG. 4, a dynamically reconfigurable processor unit 100 according to a second embodiment as illustrated in block diagram form is shown including a pair of setting registers “101a”, “101b”, a pair of flip-flops “102a”, “102b”, a pair of flip-flops “104a”, “104b”, computing devices 103, 105, and 106, a pair of flip-flops “107a”, “107b”, a pair of input data-switching units 108, 109, and an output data-switching unit 110. The computing devices 103, 105 are operable to perform either shift or mask operation. The computing device 106 is operable to perform addition and subtraction. The dynamically reconfigurable processor unit 100 according to the present embodiment further may include two different data inputs, i.e., a data input (DataIn0) 111 and a data input (dataIn1) 112, and a single data output (DataOut) 113.

The setting registers “101a”, “101b” serve as setting information storage units. The computing devices 103, 105, and 106 function as arithmetic processing units. The flip-flops “102a”, “102b” function as input data storage units, each of which is operable to store the entered data input 111. The flip-flops “104a”, “104b” operate as input data storage units as well, each of which is operable to store the entered data input 112. The flip-flops “107a”, “107b” work as output data storage units, each of which is operable to store results from arithmetic processing at the computing device 106.

The following briefly discusses how each of the dynamically reconfigurable processor units 100 according to the present embodiment is operated.

In usual processing, the setting register “101a” and flip-flops “102a”, “104a”, and “107a” are selected. The computing device 103 performs the either shift or mask operation of data from the flip-flop “102a”, while the computing device 105 performs the same operation of data from the flip-flop “104a”. As a result, respective results from the operations at the flip-flops “102a”, “104a” are delivered to the computing device 106, at which the delivered results are either added together or subtracted from therebetween. Results from the either addition or subtraction at the computing device 106 are placed into the flip-flop “107a”. The shift operation is possible to set up a shift direction and a shift width. The mask operation is possible to set up a selection from arithmetic operation types of AND- or OR-operation, and to set up mask bits for use in the former operation.

Setting information in the setting register “101a” determines whether the computing devices 103, 105 perform the either shift or mask operation, and whether the computing device 106 performs the either addition or subtraction. The course of action as described above in the usual processing is so-called “first layer” processing.

In interrupt processing, each of the dynamically reconfigurable processor units 100 selects the setting register “101b” upon receipt of an interrupting signal (IRQ) 70, thereby changing respective processing modes of the computing devices 103, 105, and 106 in accordance with setting information in the setting register “101b”. At the same time, each of the dynamically reconfigurable processor units 100 controls the input data-switching units 108, 109 and the output data-switching unit 110 in response to the interrupting signal 70, thereby providing a switchover from the flip-flops “102a”, “104a”, and “107a” to the flip-flops “102b”, “104b”, and “107b”, respectively. The computing device 103 performs a predetermined operation of data from the flip-flop “102b”, while the computing device 105 performs a predetermined operation of data from the flip-flop “104b”. As a result, respective results from the operations at the computing devices 103, 105 experience a predetermined operation at the computing device 106 before being placed into the flip-flop “107b”. The above-described course of action in the interrupt processing is so-called “second layer” processing.

As described above, each of the dynamically reconfigurable processor units 100 according to the present embodiment provides an immediate switchover from the usual processing called the “first layer” to the interrupt processing called the “second layer” in a state in which the interrupting signal 70 is rendered operative as a trigger.

In each of the dynamically reconfigurable processor units 100, the setting registers “101a”, “101b”, input data-switching units 108, 109, and output data-switching unit 110 can be both selected and controlled independently. For example, in the interrupt processing called “second layer”, the input data-switching units 108, 109 and output data-switching data 110 can be forced to switch over in mode without a switchover between the setting registers “101a”, “101b”. As a result, only input data can be changed without a change in each arithmetic processing configuration.

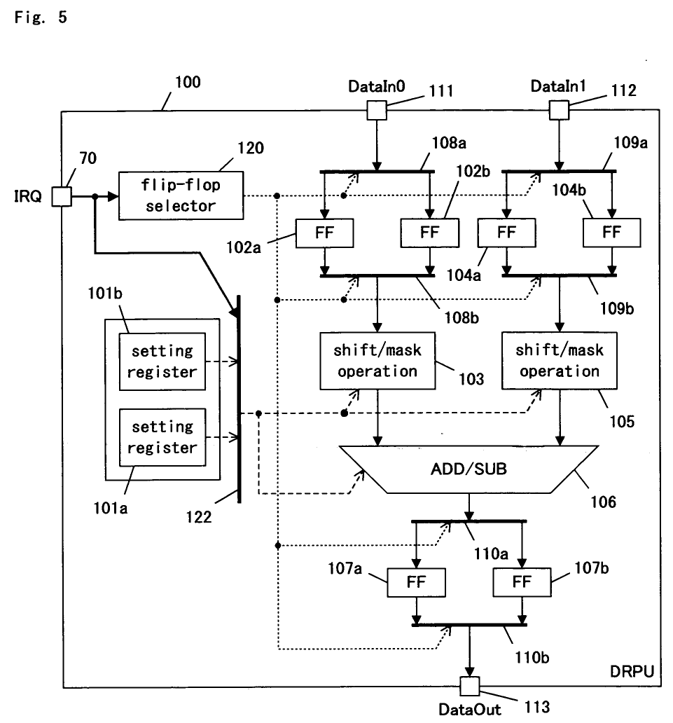

Referring to FIG. 5, details of each of the dynamically reconfigurable processor units 100 according to the second embodiment are illustrated in block diagram form. In FIG. 5, elements similar to those shown in FIG. 4 are identified by the same reference characters, and descriptions related thereto are herein omitted.

As illustrated in FIG. 5, the input data-switching unit 108 of FIG. 4 operable to provide a switchover between the flip-flops “102a”, “102b” is realized by a pair of selectors “108a”, “108b”. The input data-switching unit 109 of FIG. 4 operable to provide a switchover between the flip-flops “104a”, “104b” is realized by a pair of selectors “109a”, “109b”. The output data-switching unit 110 of FIG. 4 operable to provide a switchover between the flip-flops “107a”, “107b” is achieved by a pair of selectors “110a”, “110b”. To control all of the selectors in accordance with the interrupting signal 70, a flip-flop selector 120 is provided. In addition, a selector 122 is provided as a setting information-switching unit that is operable to provide a switchover between the setting registers “101a”, “101b” in response to the interrupting signal 70. The setting registers “101a”, “101b” operate as setting information storage units, and store setting information for use in setting arithmetic processing configurations of the computing devices 103, 105, and 106.

The following discusses switchover control responsive to the interrupting signal 70.

In the usual processing, the flip-flop selector 120 establishes connections as given below. More specifically, the selector “108a” connects the data input 111 to the flip-flop “102a” at an input thereof, while the selector “108b” connects an output of the flip-flop “102a” to the computing device 103 at an input thereof. The selector “109a” connects the data input 112 to the flip-flop “104a” at an input thereof, while the selector “109b” connects an output of the flip-flop “104a” to the computing device 105 at an input thereof. The selector “110a” connects an output of the computing device 106 to the flip-flop “107a” at an input thereof, while the selector “110b” permits an output of the flip-flop “107a” to be fed, as data output 113, out of the dynamically reconfigurable processor unit 100.

At the same time, in the usual processing, the selector 122 selects the setting register “101a” to feed the setting information from the setting register “101a” into the computing devices 103, 105, and 106, at which respective arithmetic processing steps are thereby set up.

As a result, in the usual processing, the computing device 103 performs either shift or mask operation of data from the flip-flop “102a” in accordance with the setting information from the setting register “101a”, and sends results from the operation to the computing device 106 at one of the inputs thereof. Similarly, the computing device 105 performs the either shift or mask operation of data from the flip-flop “104a”, and sends results from the operation to the computing device 106 at the other input thereof. The computing device 106 performs either addition or subtraction of these two pieces of input data from the computing devices 103, 105 in accordance with the setting information from the setting register “101a”, and places results from the addition or subtraction into the flip-flop “107a”.

Upon receipt of the interrupting signal 70 from the outside of each of the dynamically reconfigurable processor units 100, the dynamically reconfigurable processor unit 100 controls both of the flip-flop selector 120 and the selector 122 in a state in which the interrupting signal 70 is rendered operative as a trigger, thereby providing connection and setting as discussed below to execute the interrupt processing. More specifically, the selector “108a” connects the data input 111 to the flip-flop “102b” at an input thereof, while the selector “108b” connects an output of the flip-flop “102b” to the computing device 103 at the input thereof. The selector “109a” connects the data input 112 to the flip-flop “104b” at an input thereof, while the selector “109b” connects an output of the flip-flop “104b” to the computing device 105 at the input thereof. The selector “110a” connects the output of the computing device 106 to the flip-flop “107b” at an input thereof, while the selector “10b” allows an output of the flip-flop “107b” to be fed, as data output 113, out of the dynamically reconfigurable processor unit 100.

At the same time, the selector 122 selects the setting register “101b”, as the interrupting processing, to feed the setting information from the setting register “101b” into the computing devices 103, 105, and 106, at which respective arithmetic processing steps are thereby set up.

As a result, in the interrupting processing, the computing device 103 performs the either shift or mask operation of data from the flip-flop “102b” in accordance with the setting information from the setting register “101b”, and sends results from the operation to the computing device 106 at one of the inputs thereof. Similarly, the computing device 105 performs the either shift or mask operation of data from the flip-flop “104b”, and sends results from the operation to the computing device 106 at the other input thereof. The computing device 106 performs either addition or subtraction of these two pieces of input data from the computing devices 103, 105 in accordance with the setting information from the setting register “101b”, and then places results from the addition or subtraction into the flip-flop “107b”.

As described above, each of the dynamically reconfigurable processor units 100 performs a predetermined operation of the data from the flip-flops “102a”, “104a”, as the usual processing called “the first layer”, and puts results from the operation into the flip-flop “107a”. Meanwhile, upon receipt of the interrupting signal 70, each of the dynamically reconfigurable processor units 100 performs a predetermined operation of the data from the flip-flops “102b”, “104b”, as the interrupt processing called “the second layer”, in a state in which the interrupting signal 70 is rendered operative as the trigger, and then places results from the operation into the flip-flop “107b”. Thus, each of the dynamically reconfigurable processor units 100 according to the present embodiment provides a prompt switchover from the usual processing called “the first layer” to the interrupt processing called “the second layer” in the state in which the interrupting signal 70 is rendered operative as the trigger. As a result, the required processing is executable.

As seen from the above, each of the dynamically reconfigurable processor units 100 according to the present embodiment is operable to produce an interruption in the course of processing the data using a logic configuration, thereby providing a prompt switchover from a set of the pre-interrupt logic configuration-based arithmetic operation and data processed thereby to a set of another logic configuration-based arithmetic operation and data to be processed thereby. This feature makes it possible to cope with tasks that must preferentially be processed in real time. Since the setting registers “101a”, “101b”, input data-switching units 108, 109, and output data-switching unit 110 provide for a changeover in an independently controllable manner, data may be changed without a change in logic configuration, and vice versa.

Although each of the dynamically reconfigurable processor units 100 according to the present embodiment is of the two-input/one-output type, the number of the inputs and that of the outputs are not limited thereto. More specifically, they may arbitrarily be determined by configurations of the computing devices in each of the dynamically reconfigurable processor units 100.

Although each of the dynamically reconfigurable processor units 100 according to the present embodiment executes two different modes of processing, i.e., the usual processing called the “first layer” and the interrupt processing called the “second layer”, further processing called the “third or greater layers” may optionally be provided. In this instance, the flip-flops in the input and output data storage units may be increased in number in accordance with the number of processing layers, while the setting registers may be increased in number. As a result, while the first interrupt processing is performed, the higher-priority second interrupt processing is concurrently achievable.

### Third Embodiment

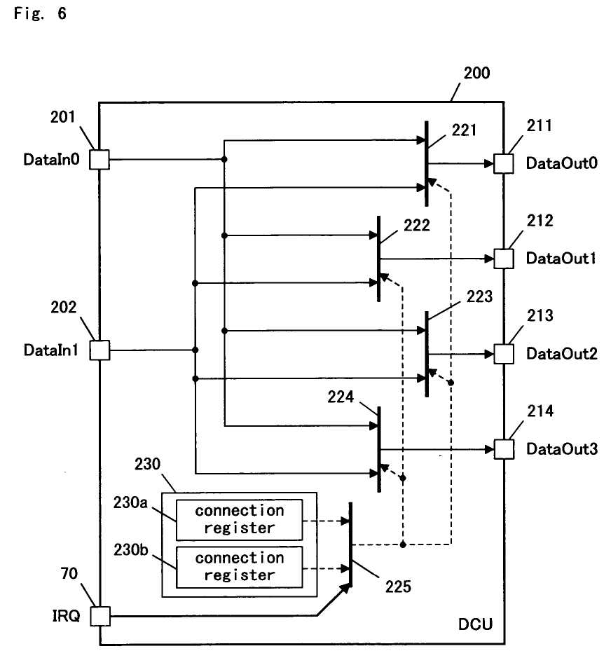

Referring to FIG. 6, a dynamically connecting unit 200 according to a third embodiment as illustrated in block diagram form is of the two-input/four-output type, and is shown including a set of selectors 221, 222, 223, and 224, a pair of connection registers “230a”, “230b”, and a single selector 225. The selectors 221, 222, 223, and 224 are operable to select connections between inputs and outputs of the dynamically connecting unit 200, and consequently serve as connecting units. The connection registers “230a”, “230b” function as connection information storage units operable to store connection information. The selector 225 is operable to select between the connection registers “230a” and “230b”.

In usual processing, the selector 225 selects the connection register “230a”, and selects respective connections of the selectors 221, 222, 223, and 224 in accordance with the connection information in the connection register “230a”. For example, the selector 221 connects an input (Datain0) 201 to an output (DataOut0) 211; the selector 222 connects an input (DataIn1) 202 to an output (DataOut1) 212; the selector 223 connects the input (Dataln1) 202 to an output (Dataout2) 213; and the selector 224 connects the input (Datain0) 201 to an output (DataOut3) 214.

In interrupt processing, when an interrupting signal 70 enters the dynamically connecting unit 200, then the selector 225 selects the connection register “230b” to establish connections for the interrupt processing, and selects respective connections of the selectors 221, 222, 223, and 224 in accordance with the connection information in the connection register “230b”.

In the dynamically connecting unit 200 according to the present embodiment, the input (Datain0) 201 as well as the input (DataIn1) 202 may be connected to all of the outputs, or alternatively may be connected to only one of them.

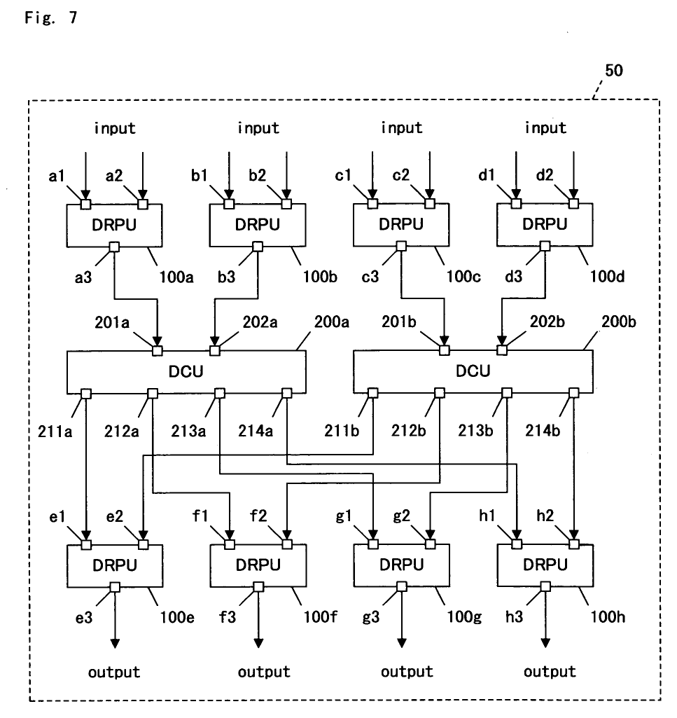

Turning now to FIG. 7, a dynamically reconfigurable logic circuit device 50 incorporating the dynamically connecting units 200 according to the present embodiment is illustrated in block diagram form as a fragmentary view. In FIG. 7, the interrupting signal 70 is omitted, which is operable to control dynamically reconfigurable processor units 100 and the dynamically connecting units 200. In FIG. 7, elements similar to those shown in FIG. 1 are identified by the same reference characters, and descriptions related thereto are herein omitted.

As illustrated in FIG. 7, the dynamically reconfigurable logic circuit device 50 includes four numbers of the dynamically reconfigurable processor units (DRPU) 100 (each of which is of the two-input/one-output type) per layer, and two numbers of the dynamically connecting units (DCU) 200 according to the present embodiment. As a result, the dynamically reconfigurable processor units 100 in the first layer can arbitrarily be connected to the dynamically reconfigurable processor units 100 in the second layer through the dynamically connecting units (DCU) 200. Such connections can be changed promptly and arbitrarily in accordance with the connection information in the connection register 230 when a switchover between the connection registers “230a” and “230b” is provided, as discussed with reference to FIG. 6, in a state in which the interrupting signal 70 is rendered operative as a trigger.

### Fourth Embodiment

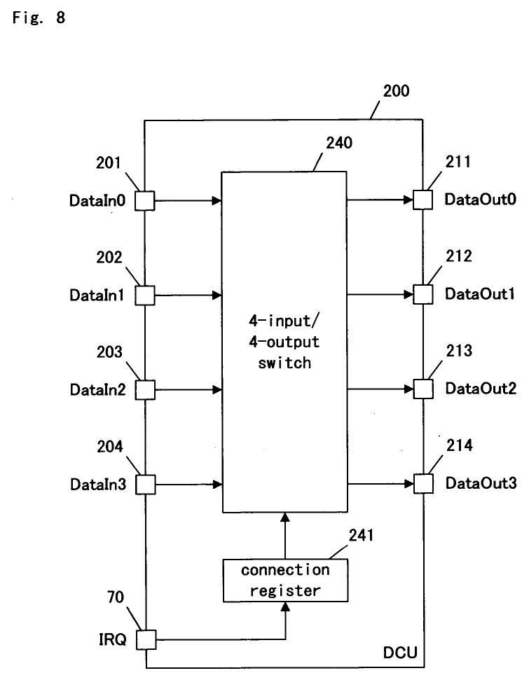

Referring to FIG. 8, a dynamically connecting unit 200 according to a fourth embodiment is illustrated in block diagram form. In FIG. 8, elements similar to those as illustrated in FIG. 6 are identified by the same reference characters, and descriptions related thereto are herein omitted.

Preferably, the dynamically connecting unit 200 according to the present embodiment is of the four-input/four-output type, and includes a four-input/four-output switch 240 and a connection register 241. The connection register 241 is operable to control connections of the four-input/four-output switch 240 in accordance with an interrupting signal 70. The four-input/four-output switch 240 is easily realized by the expanded application of the selectors 221 to 224 of FIG. 6, and therefore descriptions related thereto are herein omitted.

Assuming that dynamically reconfigurable processor units 100 of a one-input/one-output type as illustrated in FIG. 1 are arranged in array, the dynamically connecting units 200 according to the present embodiment are adapted to connect between layers formed by the arrangement of the dynamically reconfigurable processor units 100. For example, dynamically connecting units “200a”, “200c”, and “200d” in a dynamically reconfigurable logic circuit device 50 of FIG. 1 may be replaced by the dynamically connecting units 200 according to the present embodiment. As a result, logic circuit configurations as illustrated in FIGS. 2 and 3 are achievable instantly in a state in which the interrupting signal 70 is rendered operative as a trigger.

### Fifth Embodiment

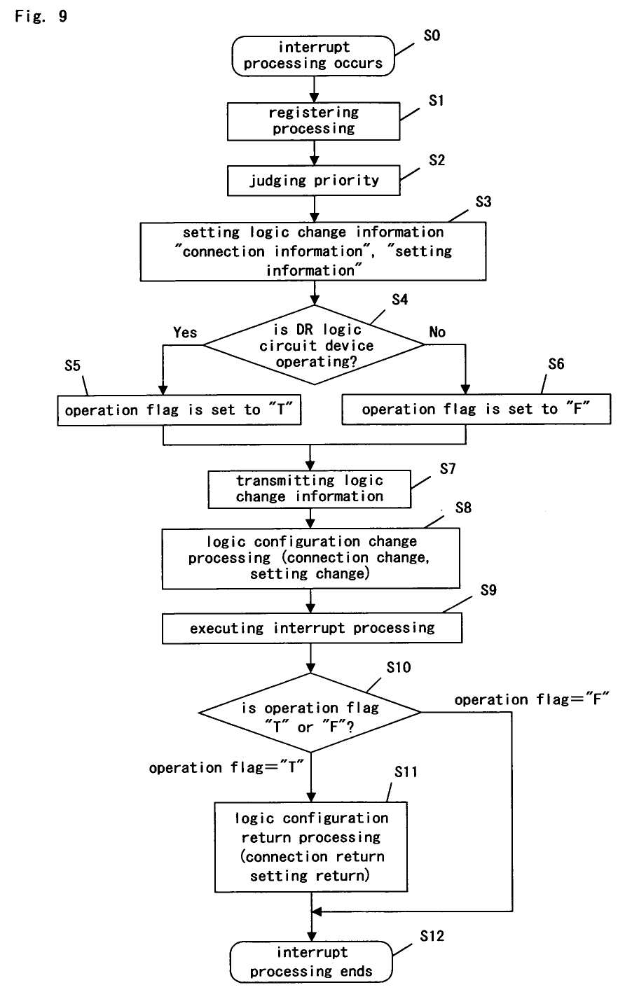

Referring to FIG. 9, an interrupt control method according to a fifth embodiment in a dynamically reconfigurable logic circuit device is illustrated in flowchart form. The following describes the interrupt control method of FIG. 9 according to the present embodiment with reference to FIGS. 1, 4, and 8.

Turning now to FIG. 1, it is assumed that processing to be preferentially executed in real time occurs in a semi-conductor integrated circuit that includes the dynamically reconfigurable logic circuit device 50. Referring back to FIG. 9, upon the occurrence of the preferential processing, the program starts at step “S0” in the flowchart of the interrupt control method according to the present embodiment.

At step “S1”, the CPU 60 of FIG. 1 prepares for interrupt processing. More specifically, the CPU 60 registers the preferential processing as the interrupt processing.

At step “S2”, the CPU 60 appreciates the priority of the preferential processing, a logic configuration of the dynamically reconfigurable logic circuit device 50, which is to be used for the preferential processing, and data. Such information is notified to the interrupt controller 61 of FIG. 1 from the CPU 60.

At step “S3”, the interrupt controller 61 prepares, as logic change information, connection and setting information required for the preferential processing, in accordance with the notified information from the CPU 60.

At step “S4”, the interrupt controller 61 determines whether the dynamically reconfigurable logic circuit device 50 of FIG. 1 is in the course of treating another task. When the determination in step “S4” results in “YES”, then the routine is advanced to step “S5”, at which an operating flag is set to “T (True)”. When the determination in step “S4” results in “No”, then the routine is advanced to step “S6”, at which the operating flag is set to “F (False)”. The operating flag is used at step “S10” as discussed later.

At step “S7”, the interrupt controller 61 issues the interrupting signal 70 to the dynamically reconfigurable logic circuit device 50 in order to execute the preferential processing as the interrupt processing. At the same time, the interrupt controller 61 transmits the connection and setting information (prepared at step “S3”) as the logic change information to the dynamically reconfigurable logic circuit device 50.

At step “S8”, the dynamically reconfigurable logic circuit device 50 changes the arithmetic processing configurations of the dynamically reconfigurable processor units 100 of FIG. 1 and the connecting configurations of the dynamically connecting units 200 of FIG. 1 in accordance with the connection and setting information from the interrupt controller 61 in a state in which the interrupting signal 70 from the interrupt controller 61 is rendered operative as a trigger.

The interrupt control method at step “S8” is now more specifically described with reference to FIGS. 4 and 8.

Referring to FIG. 8, the dynamically connecting unit 200 in receipt of the interrupting signal 70 changes connection information in the connection register 241 in accordance with the connection information from the interrupt controller 61 in the state in which the interrupting signal 70 is rendered operative as the trigger. The connection register 241 changes the connecting configuration of the four-input/four-output switch 240 in accordance with the new connection information. As a result, the dynamically reconfigurable logic circuit device 50 provides a switchover from, e.g., a logic circuit configuration as illustrated in FIG. 2 to that of FIG. 3.

At the same time, the dynamically reconfigurable processor unit 100 of FIG. 4 in receipt of the interrupting signal 70 changes setting information in the setting register “101b” in accordance with the setting information from the interrupt controller 61. Each of the dynamically reconfigurable processor units 100 changes arithmetic processing configurations of the computing devices 103, 105, and 106 in accordance with the new setting information in the setting register “101b” in the state in which the interrupting signal 70 is rendered operative as the trigger,

Each of the dynamically reconfigurable processor units 100 controls the input data-switching units 108, 109 and the output data-switching unit 110 in the state in which the interrupting signal 70 is rendered operative as the trigger, thereby providing a switchover from the flip-flops “102a”, “104a”, and “107a” to the flip-flops “102b”, “104b”, and “107b”, respectively. As a result, each of the dynamically reconfigurable processor units 100 completes the preparation for the interrupt processing as the “second layer” processing. The detailed description of step “S8” is now terminated.

At step “S9”, the dynamically reconfigurable logic circuit device 50 executes the interrupt processing after ascertaining that the dynamically reconfigurable processor units 100 and dynamically connecting units 200 are ready for the interrupt processing. Details of the interrupt processing are discussed later. The routine is advanced to step “S10” at the end of the interrupt processing.

At step “S10”, the dynamically reconfigurable logic circuit device 50 examines the operating flag that was set at step “S5” or “S6”. When the operating flag is “T” (or when the dynamically reconfigurable logic circuit device 50 remained engaged with another task before a switchover to the interrupt processing), then the dynamically reconfigurable logic circuit device 50 issues a request for return processing before the routine is advanced to step “S11”. When the operating flag is “F”, then the routine is advanced to step “S12” without the issuance of the request for return processing. At step “S12”, the present interrupt processing is terminated.

At step “S11”, each of the dynamically reconfigurable processor units 100 in receipt of the request for return processing brings the present arithmetic processing configuration back to the pre-interrupt, arithmetic processing configuration in accordance with the pre-interrupt, setting information. Each of the dynamically connecting units 200 in receipt of the request for return processing brings the present connecting configuration back to the pre-interrupt, connecting configuration in accordance with the pre-interrupt, connection information. The routine is then advanced to step “S12”, at which the interrupt processing is terminated.

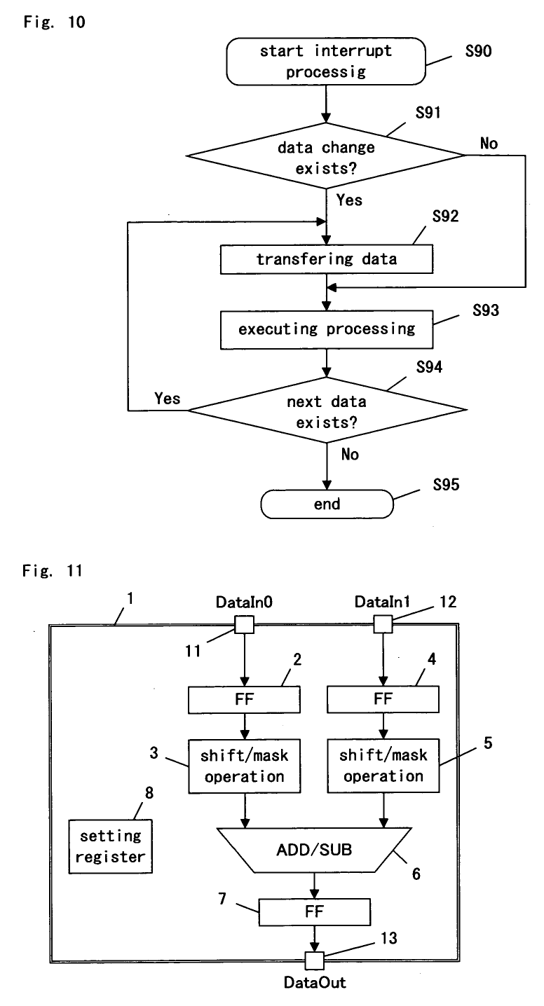

Turning now to FIG. 10, the interrupt processing according to the present embodiment is illustrated in flowchart form. The following provides a further detailed description of the execution of the interrupt processing at step “S9” of FIG. 9 with reference to FIG. 10.

At step “S90”, the interrupt processing is started. At step “S91”, a determination is made as to whether pre-interrupt, input data is used as such in the present interrupt processing, or alternatively new input data is used. When it is determined that the input data need not be changed (or when the determination in step “S91” results in “NO”), then the routine is advanced to step “S93”. When it is determined that the input data must be changed (or when the determination in step “S91” results in “YES”), then the routine is advanced to step “S92”.

At step “S92”, input data in a flip-flop “102b” is transmitted therefrom to the computing device 103. The routine is then advanced to step “S93”.

At step “S93”, the interrupt processing is executed. The routine is then advanced to step “S94”.

At step “S94”, a determination is made as to whether there are further data to be processed. When the determination in step “S94” results in “YES”, then the routine is returned to step “S92”, thereby repeating the steps “S92”, S93”, and “S94”. When the determination in step “S94” results in “NO”, then the routine is advanced to step “S95” where the interrupt processing is terminated.

The specific mode of practicing the interrupt control as illustrated in FIGS. 9 and 10 in flowchart form may be implemented as a program operable by the CPU 60 of FIG. 1.

In a semi-conductor integrated circuit that incorporates the dynamically reconfigurable logic circuit device 50, the interrupt control method according to the present embodiment allows for multi-task control and time-division multiplexing. The time-division multiplexing is controllable by programs, and the number of processing steps to be managed and the order of precedence to be managed are readily changeable.

As described above, the present invention provides processing control in real time, which has been an outstanding issue to be overcome by known dynamically reconfigurable logic circuit devices.

The dynamically reconfigurable logic circuit device 50 according to the present invention is applicable to the semi-conductor integrated circuit according to the first embodiment as well as signal processors for so-called multimedia including images and voices which must be under real-time processing control. This means that the dynamically reconfigurable logic circuit device 50 is used to provide a device possessing a logic circuit dynamically reconfigurable by programs. Consequently, only a change in logic configuration by programs provides a signal processor operable to execute several signal processing steps. As a result, a single signal processor can cope with processing that must heretofore be carried out by several signal processors, and the entire apparatus including the signal processor is achievable at low cost.

As evident from the above description, the subject-matter of the present invention is to provide the dynamically reconfigurable logic circuit device possessing the logic circuit reconfigurable and controllable in response to the interrupt signal. Therefore, various modifications and variations can be made without departing from the spirit and scope of the present invention.

The present invention advantageously provides the dynamically reconfigurable logic circuit device adapted for time-division multiplexing, and possessing an increased level of processing capability per cycle.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A dynamically reconfigurable logic circuit device comprising:
a plurality of dynamically reconfigurable processor units; and
at least one dynamically connecting unit,
wherein said at least one dynamically connecting unit changes electrical connections between inputs and outputs of said plurality of dynamically reconfigurable processor units in a state in which an interrupting signal entering said at least one dynamically connecting unit from an outside of said at least one dynamically connecting unit is rendered operative as a trigger, whereby different logic circuits are configured in said dynamically reconfigurable logic circuit device.

2. A dynamically reconfigurable logic circuit device as defined in claim 1, wherein each of said plurality of dynamically reconfigurable processor units has a plurality of arithmetic processing configurations changeable in a state in which the interrupting signal entering each of said plurality of dynamically reconfigurable processor units from an outside of each of said plurality of dynamically reconfigurable processor units is rendered operative as the trigger.

3. A dynamically reconfigurable logic circuit device as defined in claim 1, wherein each of said plurality of dynamically reconfigurable processor units includes:
at least one computing unit;
a setting information storage unit operable to store setting information for use in setting different arithmetic processing configurations in combination with said computing unit;
at least one input data storage unit operable to retain data to be entered into each of said plurality of dynamically reconfigurable processor units;
a setting information-switching unit operable to provide a switchover of the setting information to be read out from said setting information storage unit; and
an input data-switching unit operable to provide a switchover of said at least one input data storage unit,
wherein said setting information-switching unit and said input data-switching unit execute respective switchovers in a state in which the interrupting signal entering each of said plurality of dynamically reconfigurable processor units from an outside of each of said plurality of dynamically reconfigurable processor units is rendered operative as the trigger, whereby said different arithmetic processing configurations are provided in each of said plurality of dynamically reconfigurable processor units.

4. A dynamically reconfigurable logic circuit device as defined in claim 1, wherein each of said plurality of dynamically reconfigurable processor units includes:
at least one computing unit;
a setting information storage unit operable to store setting information for use in setting different arithmetic processing configurations in combination with said computing unit;
at least one input data storage unit operable to retain data to be entered into each of said plurality of dynamically reconfigurable processor units;
at least one output data storage unit operable to retain data to be fed out of each of said plurality of dynamically reconfigurable processor units;
a setting information-switching unit operable to provide a switchover of the setting information to be read out from said setting information storage unit;
an input data-switching unit operable to provide a switchover of said at least one input data storage unit; and
an output data-switching unit operable to provide a switchover of said at least one output data storage unit,
wherein said setting information-switching unit, said input data-switching unit, and said output data-switching unit execute respective switchovers in a state in which the interrupting signal entering each of said plurality of dynamically reconfigurable processor units from an outside of each of said plurality of dynamically reconfigurable processor units is rendered operative as the trigger, whereby said different arithmetic processing configurations are provided in each of said dynamically reconfigurable processor units.

5. A dynamically reconfigurable logic circuit device as defined in claim 1, wherein input data to be entered in parallel into each of said plurality of dynamically reconfigurable processor units are equal in number to output data to be fed in parallel out of each of said dynamically reconfigurable processor units.

6. A dynamically reconfigurable logic circuit device as defined in claim 1, wherein input data to be entered in parallel into each of said plurality of dynamically reconfigurable processor units are greater in number than output data to be fed in parallel out of each of said dynamically reconfigurable processor units.

7. A dynamically reconfigurable logic circuit device as defined in claim 3, wherein said at least one computing unit in each of said plurality of dynamically reconfigurable processor units performs at least one of addition, subtraction, shift operation, mask operation, and bit manipulation.

8. A dynamically reconfigurable logic circuit device as defined in claim 1, wherein said at least one dynamically connecting unit includes:
at least one connection information storage unit operable to store connection information for use in interconnecting said plurality of dynamically reconfigurable processor units; and
at least one connecting unit operable to electrically connect an output of one of said plurality of dynamically reconfigurable processor units to an input of another of said plurality of dynamically reconfigurable processor units,
wherein readout of the connection information from said connection information storage unit and electrical connection of said dynamically reconfigurable processor units through said connecting unit are performed in a state in which the interrupting signal entering said at least one dynamically connecting unit from an outside of said at least one dynamically connecting unit is rendered operative as the trigger.

9. An interrupt control method for use in time-division multiplexing in a dynamically reconfigurable logic circuit device comprising:
a plurality of dynamically reconfigurable processor units; and
at least one dynamically connecting unit,
wherein said at least one dynamically connecting unit changes electrical connections between inputs and outputs of said plurality of dynamically reconfigurable processor units, thereby allowing different logic circuits to be configured in said dynamically reconfigurable logic circuit device, said interrupt control method comprising:
transmitting an interrupting signal to said dynamically reconfigurable logic circuit device in response to occurrence of interrupt processing higher in priority than processing currently underway, the interrupting signal being transmitted to address the interrupt processing;
receiving the interrupting signal by said dynamically reconfigurable logic circuit device;
reconfiguring by said dynamically reconfigurable logic circuit device a logic circuit required for the interrupt processing, in a state in which the interrupting signal received by said dynamically reconfigurable logic circuit device is rendered operative as a trigger; and
executing the interrupt processing by said dynamically reconfigurable logic circuit device using the logic circuit reconfigured by said dynamically reconfigurable logic circuit device.

10. An interrupt control method as defined in claim 9, wherein in each of said plurality of dynamically reconfigurable processor units, said interrupt control method comprises:
transmitting an interrupting signal to said dynamically reconfigurable logic circuit device in response to occurrence of interrupt processing higher in priority than processing currently underway, the interrupting signal being transmitted to address the interrupt processing;
receiving the interrupting signal by each of said plurality of dynamically reconfigurable processor units;
changing by each of said plurality of dynamically reconfigurable processor units its arithmetic processing configuration to an arithmetic processing configuration required for the interrupt processing, in a state in which the interrupting signal received by each of said plurality of dynamically reconfigurable processor units is rendered operative as the trigger; and
executing the interrupt processing by each of said plurality of dynamically reconfigurable processor units using said arithmetic processing configuration changed by each of said plurality of dynamically reconfigurable processor units.

11. An interrupt control method for use in time-division multiplexing in a dynamically reconfigurable logic circuit device possessing a plurality of dynamically reconfigurable processor units, comprising:
transmitting an interrupting signal to said dynamically reconfigurable logic circuit device in response to occurrence of interrupt processing higher in priority than processing currently underway, the interrupting signal being transmitted to address the interrupt processing;
receiving the interrupting signal by each of said plurality of dynamically reconfigurable processor units;
selecting by each of said plurality of dynamically reconfigurable processor units input data required for the interrupt processing, in a state in which the interrupting signal received by each of said plurality of dynamically reconfigurable processor units is rendered operative as a trigger;
selecting by each of said plurality of dynamically reconfigurable processor units setting information on an arithmetic processing configuration required for the interrupt processing;
changing by each of said plurality of dynamically reconfigurable processor units said arithmetic processing configuration in accordance with the setting information; and
executing the interrupt processing by each of said plurality of dynamically reconfigurable processor units using both of the input data selected by each of said plurality of dynamically configurable processor units and said arithmetic processing configuration changed by each of said plurality of dynamically reconfigurable processor units.

12. An interrupt control method for use in time-division multiplexing in a dynamically reconfigurable logic circuit device possessing a plurality of dynamically reconfigurable processor units, comprising:
transmitting an interrupting signal to said dynamically reconfigurable logic circuit device in response to occurrence of interrupt processing higher in priority than processing currently underway, the interrupting signal being transmitted to address the interrupt processing;
receiving the interrupting signal by each of said plurality of dynamically reconfigurable processor units;
selecting by each of said plurality of dynamically reconfigurable processor units input data required for the interrupt processing, in a state in which the interrupting signal received by each of said plurality of dynamically reconfigurable processor units is rendered operative as a trigger;
selecting by each of said plurality of dynamically reconfigurable processor units setting information on an arithmetic processing configuration required for the interrupt processing;
changing by each of said plurality of dynamically reconfigurable processor units said arithmetic processing configuration in accordance with the setting information;
executing the interrupt processing by each of said plurality of dynamically reconfigurable processor units using both of the input data selected by each of said plurality of dynamically configurable processor units and said arithmetic processing configuration changed by each of said plurality of dynamically reconfigurable processor units; and
changing by each of said plurality of dynamically reconfigurable processor units a place where results from the interrupt processing are stored.

13. A semi-conductor integrated circuit comprising:
a dynamically reconfigurable logic circuit device including a plurality of dynamically reconfigurable processor units and at least one dynamically connecting unit, wherein said at least one dynamically connecting unit changes electrical connections between inputs and outputs of said plurality of dynamically reconfigurable processor units according to prescribed setting information in a state in which an interrupting signal entering said at least one dynamically connecting unit from an outside of said at least one dynamically connecting unit is rendered operative as a trigger, whereby different logic circuits are configured in said dynamically reconfigurable logic circuit device;
a processor; and
an interrupt control circuit,
wherein said processor prepares an arithmetic processing configuration required for interrupt processing, and notifies said interrupt control circuit of said arithmetic processing configuration,
wherein said interrupt control circuit prepares connection information on said dynamically reconfigurable logic circuit device in accordance with said arithmetic processing configuration required for the interrupt processing, and notifies said dynamically reconfigurable logic circuit device of the connection information together with an interrupting signal, and
wherein said plurality of dynamically reconfigurable processor units in said dynamically reconfigurable logic circuit device change their arithmetic processing configurations in accordance with the setting information in a state in which the interrupting signal transmitted from said interrupt control circuit is rendered operative as a trigger, while said at least one dynamically connecting unit changes the electrical connections between the inputs and outputs of said plurality of dynamically reconfigurable processor units in accordance with the connection information, whereby different logic circuits are configured in said dynamically reconfigurable logic circuit device.

14. A semi-conductor integrated circuit as defined in claim 13, wherein said interrupt control circuit is part of said processor.
